(19) United States
(12) Patent Application Publication
(10) Pub. No.: US 2017/0203625 A1
(43) Pub. Date: Jul. 20, 2017

(54) BEARING SHOE FOR THE MOUNTING OF A LEAF SPRING END OF A LEAF SPRING

(71) Applicant: Benteler Automobiltechnik GmbH, Paderborn (DE)

(72) Inventors: Rodscha Drabon, Salzkotten (DE); Sebastian Saggel, Brakel (DE); Peter Koczar, Paderborn (DE); Ullrich Hammelmaier, Paderborn (DE)

(21) Appl. No.: 15/408,763

(22) Filed: Jan. 18, 2017

(30) Foreign Application Priority Data
Jan. 18, 2016 (DE) 10 2016 100 743.9

(51) Int. Cl. B60G 11/12; B29C 45/14

(52) U.S. Cl. CPC B60G 11/12; B29C 45/14467; B60G 2206/81012; B60G 2206/821; B60G 2204/41; B60G 2204/121; B29K 2021/00

(57) ABSTRACT

The disclosure relates to a bearing shoe for mounting a leaf spring end of a leaf spring on a vehicle body of a motor vehicle, with a receiving recess configured to house the leaf spring end; a bearing opening configured to mount the bearing shoe on the vehicle body, wherein the bearing opening is confined by an inner wall; and an elastomer bearing disposed in the bearing opening, wherein the elastomer bearing comprises an inner sleeve and an elastomer disposed between the inner sleeve and the inner wall of the beating opening and directly contacts the inner wall of the bearing opening.

### CROSS-REFERENCE TO RELATED APPLICATIONS

This application claims priority to German patent application No. 10 2016 100 743,9, entitled “Lagerschuh für die Lagerung eines Blattfederendes einer Blattfeder”, and filed on Jan. 18, 2016 by the assignee of this application, the entire disclosure of which is incorporated by reference for all purposes.

### BACKGROUND

The present disclosure relates to he mounting of a leaf spring in a vehicle, in particular in a motor vehicle.

For suspending a wheel in a vehicle, for example in a motor vehicle or in a rail vehicle, a leaf spring, which is for example designed as a longitudinal leaf spring or a transverse leaf spring, can be used.

A leaf spring is often made from a fiber-composite material and mounted unilaterally on a bearing shoe. In some cases, a leaf spring end of the leaf spring is inserted into a holding space of the bearing shoe and bonded, for example in a force-locking manner, with the bearing shoe.

The bearing shoe usually comprises a bearing opening for twistable mounting, in which an elastomer bearing with an inner sleeve, an outer sleeve and an in between vulcanized elastomer is pressed. However, the possible surface corrosion of the outer sleeve of the elastomer bearing is thereto disadvantageous.

It is thus the task of the present disclosure to provide an improved bearing shoe for the mounting of a leaf spring.

This task is solved by the features of the independent patent claims. Further advantageous examples are subject of the description, the figures as well as the dependent claims.

### SUMMARY

The present disclosure is based on the knowledge that the task to provide an improved bearing shoe for the mounting of a leaf spring can be solved by omitting the outer sleeve of the rubber bearing as the elastomer directly contacts the bearing opening of the bearing shoe. The contacting can be a cohesive bond, for example a vulcanization bonding or a force-locking bond and/or can be realized by pressing the elastomer into the bearing opening.

Thereby, it is advantageously achieved, that the elastomer contacting the inner wall of the bearing opening protects the inner wall of the bearing opening from a surface corrosion.

According to a first aspect, the disclosure relates to a bearing shoe for the mounting of a leaf spring end of a leaf spring on a vehicle body of a motor vehicle, with a receiving recess for the housing of the leaf spring end, a bearing opening for the mounting of the bearing shoe on the vehicle body, wherein the bearing opening is confined by an inner wall and an elastomer bearing, which is disposed in the bearing opening, wherein the elastomer bearing comprises an inner sleeve and an elastomer, which is disposed between the inner sleeve and the inner wall of the bearing opening and directly contacts the inner wall of the bearing opening.

The elastomer bearing is for example designed integrated or pressed into the bearing shoe.

According to one example, the elastomer is cohesively bonded to the inner wall, for example by means of a vulcanization bonding, and/or wherein the elastomer is pressed into the bearing opening and/or wherein the elastomer is bonded to the inner wall in a force-locking or form-fitting manner.

A surface corrosion of the inner wall can be reduced by the cohesive bonding or pressing of the elastomer bearing.

According to one example, the elastomer is cohesively bonded to an outer wall of the inner sleeve. The cohesive bond can be a vulcanization bonding or an adhesive bond. The outer wall of the inner sleeve is thereby firmly joined with the elastomer. Thus, the elastomer is disposed between the inner sleeve and the bearing opening. Thereby an elastic mounting of the inner sleeve in the bearing opening is achieved advantageously.

According to one example the outer wall of the inner sleeve is contoured axially, for example it comprises longitudinal grooves or longitudinal fins to prevent a twisting of the inner sleeve relative to the elastomer. Due to the axial contouring of the inner sleeve, the latter is in a form-fit engagement with the elastomer, which prevents the twisting of the inner sleeve relative to the elastomer. Moreover, the contouring increases the surface of the outer wall of the inner sleeve for the cohesive bonding with the elastomer, whereby an even firmer bond with the elastomer can be achieved.

According to one example the inner wall of the bearing opening is contoured axially, for example it comprises longitudinal grooves or longitudinal fins to prevent a twisting of the outer sleeve relative to the elastomer. Due to the axial profiling of the inner wall of the bearing opening, the advantages mentioned with regard to the axial profiling of the outer wall of the inner sleeve are achieved.

According to one example, the elastomer is fixed immovably in the bearing opening, for example it is fixed immovably by over-molding or pressing onto the inner wall of the bearing opening or onto the outer wall of the inner sleeve. Thereby the advantage is achieved that the inner sleeve can be displaced by a deformation of the fixed elastomer in the bearing opening, whereby an advantageous and progressively increasing bearing stiffness can be achieved.

According to one example, the inner sleeve has a circular or a longitudinal, for example oval or rectangular, cross section. Due to the different cross sections of the inner sleeve, different mounting positions of the bearing shoe in the vehicle can be considered. The longitudinal cross section can be for example elliptic with a long axis which depending on the mounting position extends vertically or horizontally.

According to one example, the inner sleeve has a longitudinal cross section, wherein the bearing opening has a longitudinal cross section, wherein the inner sleeve is twistable relative to the bearing opening in the bearing opening by deformation, for example compression, of the elastomer, and wherein the elastomer is designed to exert an increasing counterforce, for example a counterforce counteracting the twisting, with increasing degree of twisting of the inner sleeve. Thereby the advantage is achieved that the inner sleeve can be displaced by a deformation of the elastomer in the bearing opening, whereby an advantageous and progressively increasing bearing stiffness can be achieved.

According to one example, the bearing opening has a circular or a longitudinal, for example oval or rectangular, cross section. The cross section of the bearing opening can have the form of the cross section of the inner sleeve so that a progressively increasing bearing stiffness can be achieved in longitudinal cross sections.

Due to the varying design of the geometric form of the bearing opening, different mounting positions of the bearing shoe can further be taken into account, whereby different dynamics can be set. If the bearing opening is oval, then it is for example designed in the form of an oblong hole with a long axis which can extend in a horizontal or vertical direction with respect to the particular mounting position. However, the long axis of the oblong hole can form an acute angle with respect to the horizontal direction or the vertical direction or the extension direction of the receiving opening.

According to one example, the respective cohesive bond is a vulcanization bonding or an adhesive bond. The respective cohesive bond can be the cohesive bond between the inner sleeve of the bearing opening and the elastomer and/or the cohesive bond between the outer wall of the inner sleeve and the elastomer. The elastomer can, for example, be injected between the outer wall of the inner sleeve and the inner wall of the bearing opening. After the injecting the respective cohesive bond can be established by vulcanization. The elastomer can, however, be produced with the outer wall of the inner sleeve and the inner wall of the bearing opening by an adhesive bonding for example by using an adhesive layer which interacts with the injected elastomer,

According to one example, the elastomer is over-molded onto the respective wall, especially the inner wall of the bearing opening or the outer wall of an inner sleeve placed in the hearing opening. By over-molding the elastomer, the latter can efficiently be inserted into the bearing opening. After the injecting, for example, a vulcanization can be carried out to achieve a cohesive bond.

According to one example, the bearing opening is shaped longitudinally, and the long axis of the hearing opening extends parallel or angled with respect to an extension direction of the receiving recess. Thereby different mounting positions of the bearing shoe can be considered. Moreover, the vehicle dynamics can thereby he affected.

According to one example, the elastomer has a uniform thickness circumferentially or the elastomer comprises a first elastomer section with a first thickness and a second elastomer section with a second thickness circumferentially, wherein the first thickness and the second thickness are different. Due to the different thicknesses of the elastomer, distinct and directionally dependent stiffnesses can be achieved.

According to one example, the first elastomer section faces the receiving recess and the second elastomer section connects to the first elastomer section circumferentially or the first elastomer section and the second elastomer section are circumferentially adjacent elastomer sections. The first elastomer section can for example be thicker than the second elastomer section.

According to one example, the leaf spring end is insertable into the receiving recess and/or attachable to the receiving recess in a force-locking or clampable manner. The receiving recess can be laterally opened or closed.

According to a second aspect, the disclosure relates to a leaf spring assembly with a leaf spring which comprises a leaf spring end and the bearing shoe according to one of the preceding claims for the mounting of the leaf spring end.

According to a third aspect, the disclosure relates to a method for manufacturing a bearing shoe for the mounting of a leaf spring end of a leaf spring on a vehicle body of a motor vehicle, with providing a basic bearing shoe with a receiving recess for the mounting of a leaf spring end and with a bearing opening for the mounting of the bearing shoe on a vehicle body, wherein the bearing opening comprises an inner wall, inserting of inner sleeve into the bearing opening, wherein the inner sleeve comprises an outer wall, and introducing an elastomer between the inner sleeve and the inner wall of the bearing opening to create a elastomer bearing.

The method can be used for example to produce a beating shoe according to the first aspect.

According to one example, the elastomer is over-molded during the step of injecting onto the inner wall of the bearing opening and onto the outer wall of the inner sleeve. Thereby the elastomer bearing is integrated into the bearing shoe in a particularly production efficient manner.

According to one example, the over-molded elastomer is vulcanized for producing a material bond. Thereby the cohesive bond is formed in a particular production efficient manner.

### BRIEF DESCRIPTION OF THE DRAWINGS

Examples of the principles of this disclosure are described in detail in relation to the enclosed figures.

FIGS. 1-8 show examples of the bearing shoe;

FIG. 9 shows an inner sleeve;

FIG. 10 shows a bearing shoe cross section; and

FIGS. 11a and 11b show elastomer bearing cross sections.

### DETAILED DESCRIPTION OF THE DRAWINGS

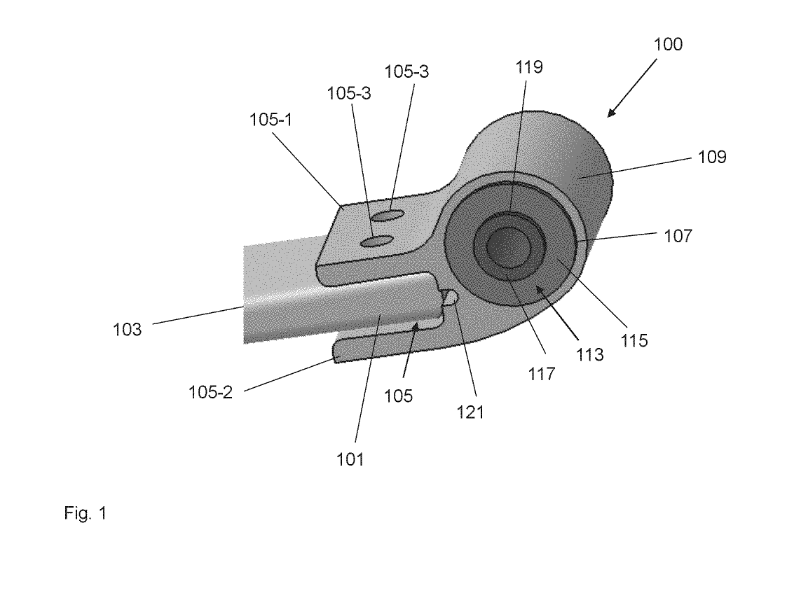

FIG. 1 shows a bearing shoe 100 for the mounting of a leaf spring end 101, illustrated by way of example in FIG. 1, of a leaf spring 103.

The bearing shoe 100 comprises a receiving recess 105 for the housing of the leaf spring end 103. The receiving recess 105 is confined by the opposing ridges 105-1, 105-2. which can for example define the receiving recess 105. The receiving recess 105 can be open laterally. The ridges 105-1, 105-2 can for example run parallel to each other so that the leaf spring end 101 is insertable into the receiving recess 105. In at least one of the ridges 105-1, 105-2 bores 105-3 can be provided which can serve for receiving the fastening screws for the force-locking attachment of the leaf spring end 101 in the receiving recess 105.

A bearing opening 107 which is confined by a bearing sleeve 109 is arranged downstream of the receiving recess 105. The bearing sleeve 109 can comprise a cylindrical form and have for example a circular cross section. The bearing opening 107 is confined by the inner wall 111 of the bearing sleeve 109. An elastomer bearing 113 with an elastomer 115 is arranged inside the bearing opening 107. The elastomer 115 is bonded cohesively to the inner wall 111 of the bearing opening 107, for example by means of a vulcanization bonding and/or by pressing into the bearing opening 107. Thereby the elastomer bearing 113 is integrated into the bearing shoe 100.

Furthermore, the elastomer 115 can surround an inner sleeve 117 whose outer wall 119 can cohesively be bonded, for example by means of a vulcanization bonding or by in-pressing, to the elastomer 115. Moreover, the outer wall 119 of the inner sleeve 117 can comprise longitudinal profiles, which are not shown in FIG. 1, and which extend in the direction of longitudinal extension of the inner sleeve 117.

The inner sleeve 117 serves as a housing of a bearing bolt, not shown in Fig with which the bearing shoe 100 can be mounted on a vehicle body, not shown in FIG. 1 for example a vehicle body component.

The bearing shoe 100 further comprises a balance groove 121 which is formed in the bearing sleeve 109 between the ridges 105-1, 105-2. A circumference of the bearing opening 107 can be reduced by the balance groove 121 to account for a shrinking of the elastomer 115 after vulcanization.

The bearing shoe 100 shown in FIG. 1 can for example be intended for a rear mounting of the leaf spring end 101.

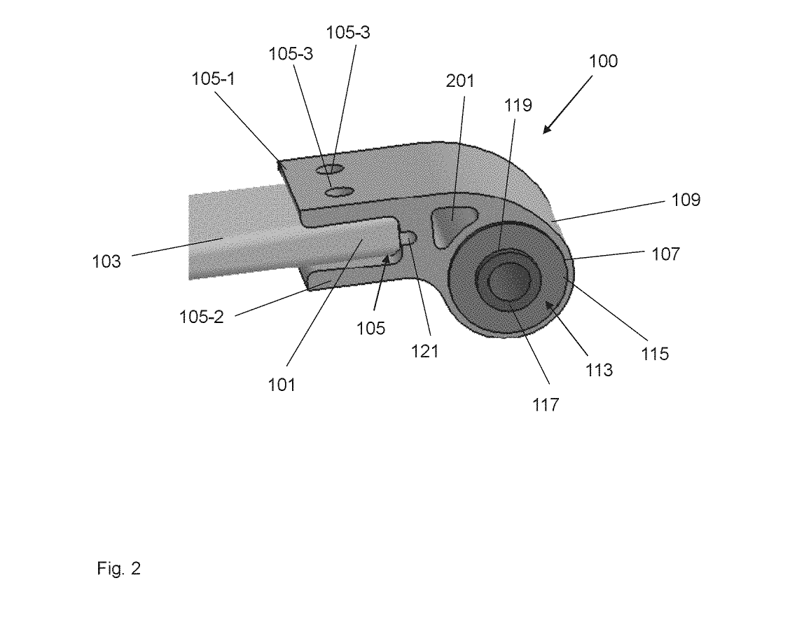

FIG. 2 shows one example of the bearing shoe 100, which can be intended for a front mounting of the leaf spring end 101.

The bearing shoe 100 depicted in FIG. 2 comprises, according to one example, an impact area 201, which is disposed between the receiving recess 105 and the sleeve-shaped bearing sleeve 1109. The impact area 201 serves for example to receive impact energy and is optional.

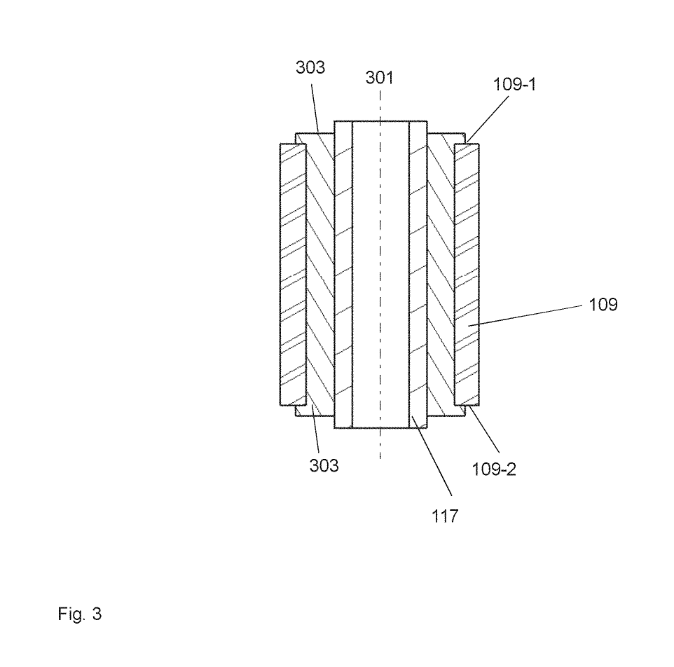

FIG. 3 shows a cross section through the bearing shoe 100 depicted in FIG. 1 and FIG. 2 along the central longitudinal axis 301. The elastomer 115 is disposed between the inner sleeve 117 and the bearing sleeve 109 and comprises optional side collars 303, which engage at least partially around the front walls 109-1, 109-2 of the bearing sleeve 109. The bearing sleeve 109 is thereby at least partially protected from lateral impacts.

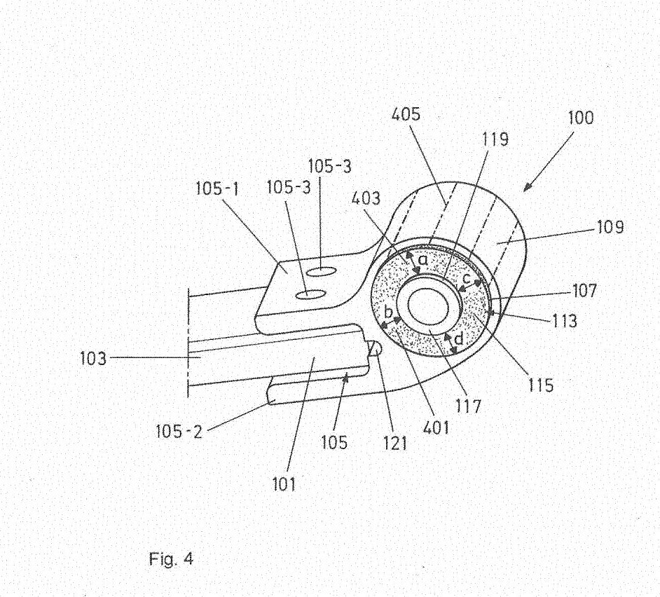

The elastomer 115 can circumferentially comprise a constant thickness. According to one example the elastomer 115 can circumferentially vary in thickness. This example is shown in FIG. 4 as an illustration of the bearing shoe 100 depicted in FIG. 1. The radial thicknesses a, b, c, d of the elastomer 115 depicted in FIG. 4 can be equal however they do not have to be all equal.

According to one example the thickness a and d, on the one hand, as well as the thicknesses b and c, on the other hand, can respectively be equal. The thickness b of the elastomer section 401 facing the receiving recess 105 can, however, be smaller than the thickness a of the second elastomer section 403 adjoining the first elastomer section 401. For example the bearing stiffness in a spring longitudinal direction can thus be increased.

According to one example the thickness b of the first elastomer section 401 can be greater than the thickness a of the second elastomer section 403. A softer tuning is thereby achieved, which can possibly lead to more comfort.

Moreover, in FIG. 4, longitudinal grooves 405 are illustratively depicted, which are formed in the inner wall 107 of the beating sleeve 109. These examples are illustratively shown in the subsequent figures.

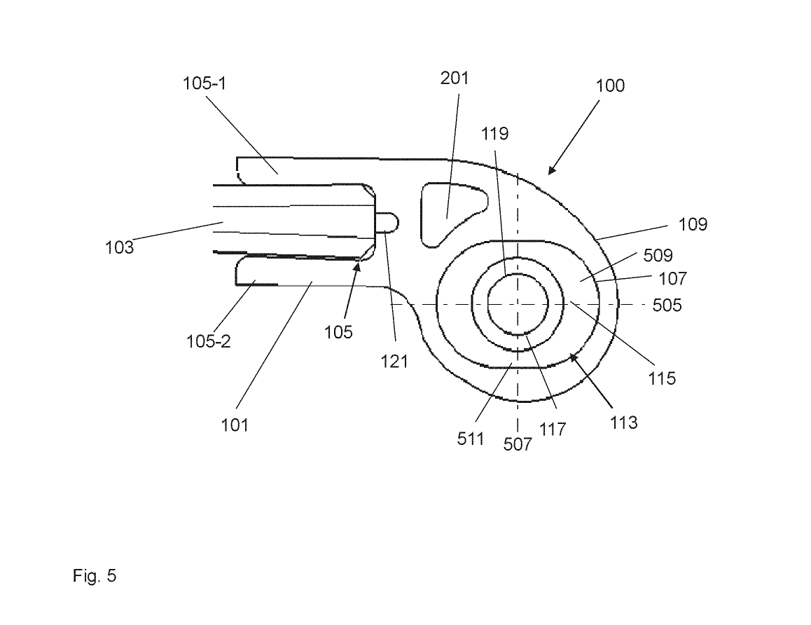

In FIG. 5, one example of the bearing shoe 100 is shown, in which the bearing opening 107 is formed ovally and/or in the direction of an oblong hole. A long axis of the bearing opening 107 extends, for example, in the direction of the X-axis 505, which for example forms the horizontal axis. The X-axis 505 is perpendicular to the Z-axis 507, which can form a vertical axis.

In the illustrative example shown in FIG. 5, the inner sleeve 117 has a circular cross section. The elastomer 115 with an oval form in the bearing opening 107 has thus elastomer sections which have different thicknesses, for example first elastomer sections 509 and second elastomer sections 511, which are respectively disposed opposite to each other. The first elastomer sections 509 can for example be thicker than the second elastomer sections 511, whereby for example more suspension comfort is achieved, The first elastomer sections 509 can, however, be less thick than the second elastomer sections 511, whereby the bearing stiffness is increased.

The bearing shoe shown in FIG. 5 can for example be intended for the front mounting of the leaf spring end 101.

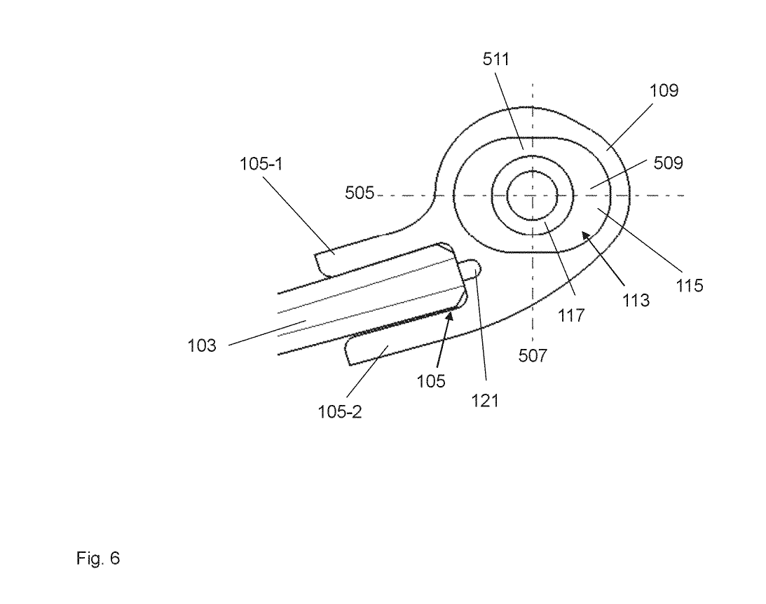

In FIG. 6 one example of the bearing shoe 100 for the rear mounting of the leaf spring end 105 is shown. In the example shown in FIG. 6, the bearing opening 107 is formed in the shape of the oblong hole depicted in FIG. 5 whose long axis extends in the direction of the X-axis 505.

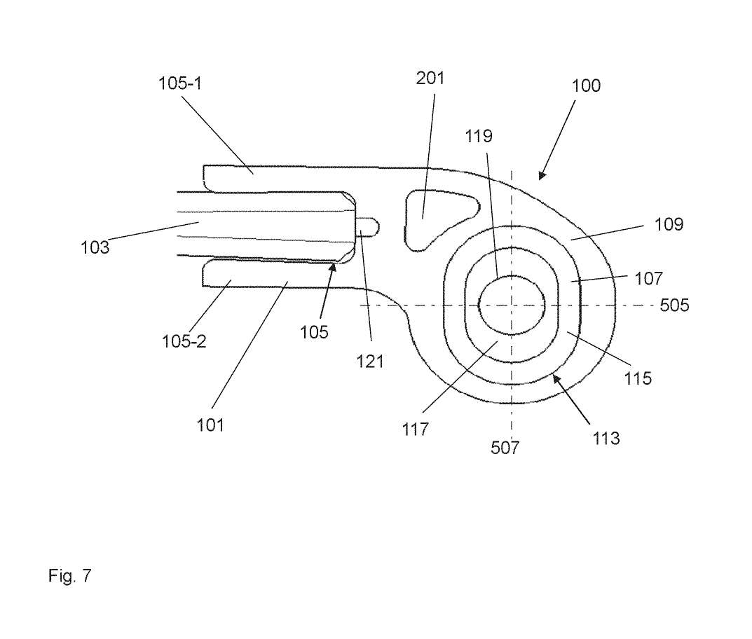

In FIG. 7 a cross section through the bearing shoe 100 is shown in which, as opposed to the example shown in FIG. 5, the bearing opening 107 is formed ovally with a long axis which extends in direction of the Z-axis 507.

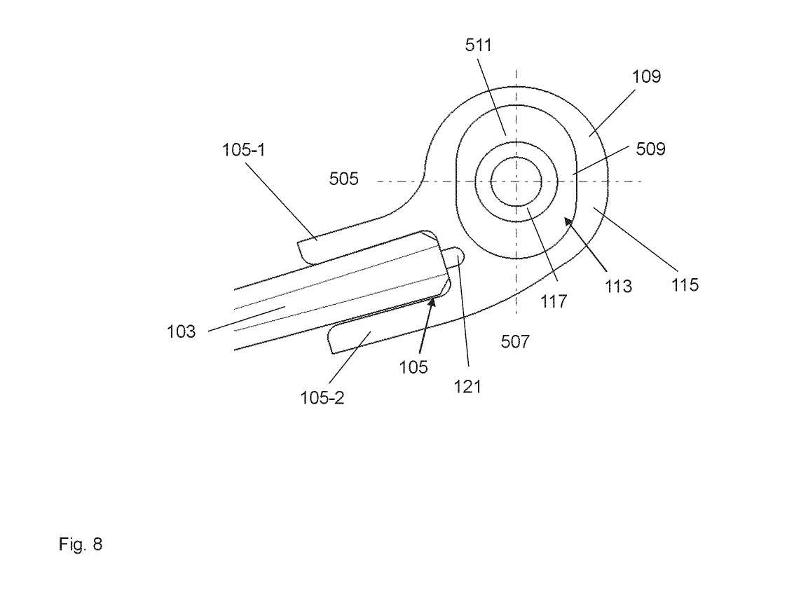

FIG. 8 a cross section through the bearing shoe 100 is shown in which, as opposed to the example shown in FIG. 6, the bearing opening 107 is formed ovally with a long axis which extends in direction of the Z-axis 507.

As shown in FIGS. 5 and 6, the inner sleeve 117 can have a circular cross section. According to one example the inner sleeve 117 can circumferentially have an oval cross section which follows the oval form of the bearing opening 107. This example is illustratively shown in FIG. 7. In contrast to the examples of the bearing shoe 100 shown in FIGS. 5 and 6, the long axis of the bearing shoe shown in FIG. 7 extends in the direction of the Z-axis 507 also for example in the vertical direction.

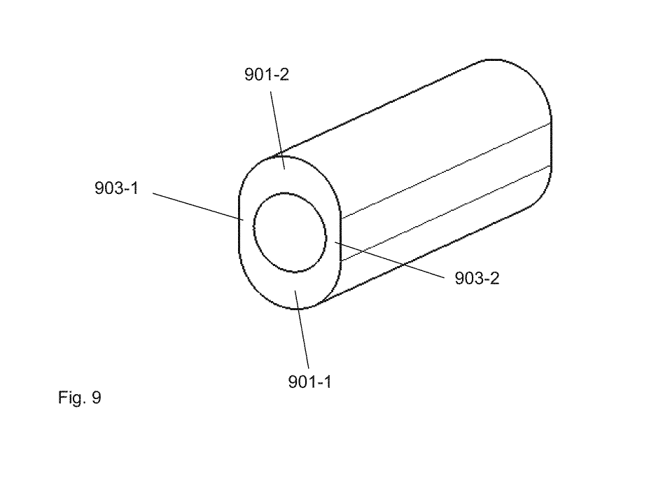

The inner sleeve 117 thereby has an oval outer shape, wherein the bearing bore 701 of the inner sleeve 117 can have a circular cross section. The inner sleeve 117 can thereby circumferentially have different thicknesses as shown in FIG. 9.

The inner sleeve 117 depicted in FIG. 9 comprises opposing first sleeve sections 901-1, 901-2 which are thicker than the lateral sections 903-1, 903-2 which are disposed along the X-axis 507 in the installed position.

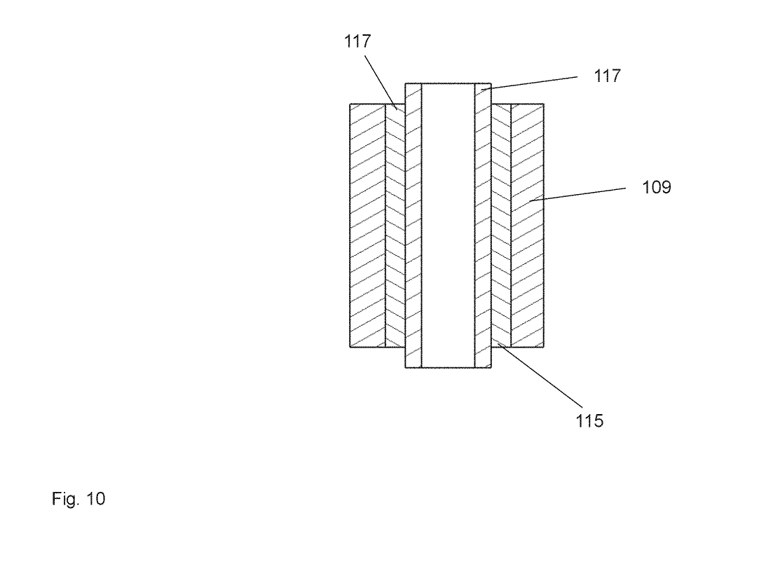

In FIG. 10 a cross section through the bearing shoe 100 according to the examples shown in FIGS. 7 and 8 is shown. For example, a circumferentially constant thickness of the elastomer 115, as shown in FIG. 7, follows from the oval profile of the outer contour and/or the inner sleeve 117.

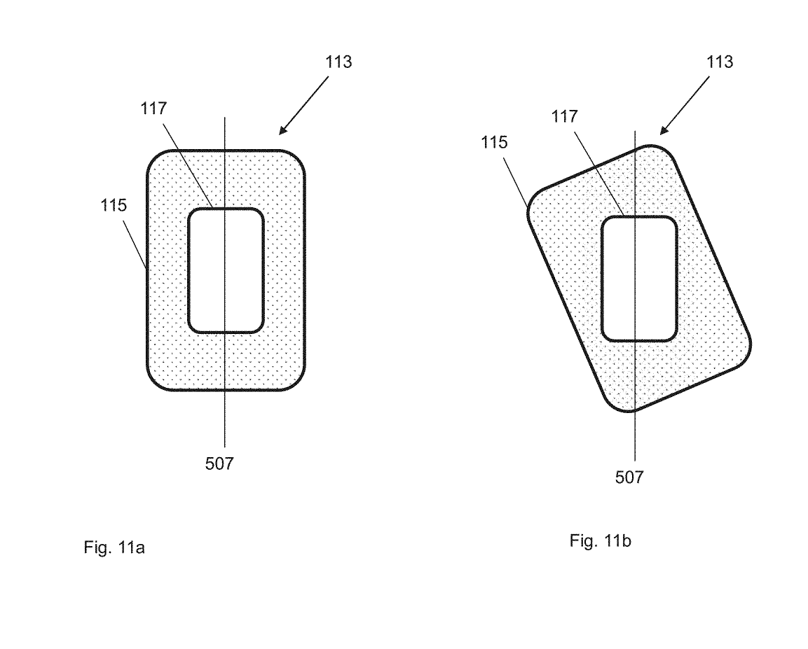

In FIG. 11a and 11b a cross section through the elastomer bearing 113 is shown. The inner sleeve 117 and the bearing opening 107 have an elongated cross section which is rectangular with rounded corners, as shown in FIG. 11a and 11b. The inner sleeve 117 is twistable in the bearing opening 107 by deformation, for example compression, of the elastomer 115 relative to the bearing opening 107. With an increasing degree of twisting of the inner sleeve 117, the elastomer 115 is increasingly compressed, whereby an increasing counter force, for example a counter force counteracting the twisting, is exerted. A progressively increasing bearing stiffness can thereby be achieved.

The inner sleeve 117 is for example bolted to a vehicle body. With a spring compression/deflection of the wheel, the elastomer 115, which can be a rubber material, twists. Tension in the elastomer is thereby built up so that the more the inner sleeve 117 twists relative to the bearing shoe 100, the stiffer the elastomer bearing 113 gets. Consequently, an elastomer beating 113 with a progressive stiffness is obtained. The progression occurs when the bearing opening 107 (bearing eye) and the inner sleeve 117 are elongated for example similarly oval or rectangular. The longitudinal axes of the oval forms can thereby extend perpendicular, i.e. in direction of the Z-axis 507. Such a mounting can be provided in the front as well as in the rear bearing shoe 100 or in both bearing shoes 100 so that the tension can advantageously be distributed over two bearing shoes.

### LIST OF REFERENCE NUMERALS

100 bearing shoe

101 leaf spring end

103 leaf spring

105 receiving recess

105-1 ridge

105-2 ridge

107 bearing opening

109 walling

109-1 front wall

109-2 front wall

111 inner wall

113 elastomer bearing

115 elastomer

117 inner sleeve

119 outer wall

121 balance groove

201 impact area

301 central longitudinal axis

303 side collar

401 first elastomer section

403 second elastomer section

405 longitudinal groove

505 X-axis

507 Z-axis

509 first elastomer section

511 second elastomer section

701 bearing sleeve

901-1 sleeve section

901-2 sleeve section

903-1 side section

903-2 side section

a, b, c, d thickness

What is claimed is:

1. A bearing shoe for mounting a leaf spring end of a leaf spring on a vehicle body of a motor vehicle, comprising:
a receiving recess configured to house the leaf spring end;
a bearing opening configured to mount the bearing shoe on the vehicle body, wherein the bearing opening is confined by an inner wall; and
an elastomer bearing disposed in the bearing opening, wherein the elastomer bearing comprises an inner sleeve and an elastomer disposed between the inner sleeve and the inner wall of the bearing opening and directly contacts the inner wall of the bearing opening.

2. The bearing shoe according to claim 1, wherein the elastomer is cohesively bonded to the inner wall by means of a vulcanization bonding, or wherein the elastomer is pressed into the beating opening or wherein the elastomer is bonded to the inner wall in a. force-locking or form-fitting manner.

3. The bearing shoe according to claim 1, wherein the elastomer is cohesively bonded to an outer wall of the inner sleeve.

4. The bearing shoe according to claim 3, wherein the outer wall of the inner sleeve is contoured axially and comprises longitudinal grooves or longitudinal fins configured to prevent a twisting of the inner sleeve relative to the elastomer, or wherein the inner wall of the bearing opening is contoured axially and comprises longitudinal grooves or longitudinal fins to prevent a twisting of an outer sleeve relative to the elastomer.

5. The bearing shoe according to claim 3, wherein the elastomer is fixed immovably in the bearing opening by over-molding or pressing onto the inner wall of the bearing opening or onto the outer wall of the inner sleeve.

6. The bearing shoe according to claim 1, wherein the bearing opening comprises one of a circular, a longitudinal, an oval, or a rectangular cross section.

7. The bearing shoe according to claim 1, wherein the inner sleeve comprises one of a circular, a longitudinal, an oval, or a rectangular cross section.

8. The bearing shoe according to claim 1, wherein the inner sleeve comprises a longitudinal cross section, wherein the bearing opening comprises a longitudinal cross section, wherein the inner sleeve is twistable relative to the bearing opening in the bearing opening by compression, of the elastomer, and wherein the elastomer is configured to exert an increasing counterforce counteracting the twisting, with increasing degree of twisting of the inner sleeve.

9. The hearing shoe according to claim 6, wherein the hearing opening is shaped longitudinally, and wherein a long axis of the bearing opening extends parallel or angled with respect to an extension direction of the receiving recess.

10. The bearing shoe according to claim 1, wherein the elastomer comprises a uniform thickness circumferentially, or wherein the elastomer comprises a first elastomer section with a first thickness and a second elastomer section with a second thickness circumferentially, wherein the first thickness and the second thickness are different.

11. The hearing shoe according to claim 10, wherein the first elastomer section faces the receiving recess, and wherein the second elastomer section connects to the first elastomer section circumferentially, wherein the first elastomer section and the second elastomer section are circumferentially adjacent elastomer sections.

12. The hearing shoe according to claim 1, wherein the leaf spring end is insertable into the receiving recess and/or attachable to the receiving recess in a force-locking or clampable manner.

13. A leaf spring assembly, comprising:
a leaf spring comprising a leaf spring end; and
a hearing shoe configured to mount the leaf spring end on a vehicle body of a motor vehicle, wherein the bearing shoe comprises:
a receiving recess configured to house the leaf spring end;
a bearing opening configured to mount the bearing shoe on the vehicle body, wherein the bearing opening is confined by an inner wall; and
an elastomer bearing disposed in the bearing opening, wherein the elastomer bearing comprises an inner sleeve and an elastomer disposed between the inner sleeve and the inner wall of the bearing opening and directly contacts the inner wall of the bearing opening.

14. The leaf spring assembly according to claim 13, wherein an outer wall of the inner sleeve is contoured axially and comprises longitudinal grooves or longitudinal fins configured to prevent a twisting of the inner sleeve relative to the elastomer, or wherein the inner wall of the bearing opening is contoured axially and comprises longitudinal grooves or longitudinal fins to prevent a twisting of an outer sleeve relative to the elastomer.

15. The leaf spring assembly according to claim 13, wherein an outer wall of the inner sleeve is contoured axially and comprises longitudinal grooves or longitudinal fins to prevent a twisting of the inner sleeve relative to the elastomer, or wherein the inner wall of the bearing opening is contoured axially and comprises longitudinal grooves or longitudinal fins to prevent a twisting of an outer sleeve relative to the elastomer.

16. A method for manufacturing a bearing shoe for the mounting of a leaf spring end of a leaf spring on a vehicle body of a motor vehicle, comprising:
providing a basic bearing shoe with a receiving recess configured to mount the leaf spring end and with a bearing opening configured to mount the bearing shoe on the vehicle body, wherein the beating opening is confined by an inner wall;
inserting an inner sleeve into the bearing opening, wherein the inner sleeve comprises an outer wall; and
introducing an elastomer between the inner sleeve and the inner wall of the bearing opening to create an elastomer bearing.

17. The method for manufacturing according to claim 16, wherein the elastomer is over-molded during a step of injecting onto the inner wall of the bearing opening and onto the outer wall of the inner sleeve.

18. The method for manufacturing according to claim 16, wherein the elastomer is vulcanized onto the inner wall of the bearing opening.

19. The method for manufacturing according to claim 16, wherein the elastomer is pressed into the bearing opening.

20. The method for manufacturing according to claim 16, wherein the elastomer is bonded in a force-locking, or form-fitting manner to the inner wall of the bearing opening.
